(19) United States
(12) Patent Application Publication
(10) Pub. No.: US 2002/0112385 A1
(43) Pub. Date: Aug. 22, 2002

(54) Structures of christmas decorations

(76) Inventor: Jessica Wang, Taipei (TW)

Correspondence Address: Supreme Patent Services, Post Office Box 3318, Saratoga, CA, 95070, US

(21) Appl. No.: 09/792,153

(22) Filed: Feb. 22, 2001

(51) Int. Cl. G09F 1/08

(52) U.S. Cl. 40/540

(57) ABSTRACT

A structure of Christmas decorations includes a flat main body and a plurality of ramified bodies, whose edge contours are provided with encircling rims thereof, and the areas surrounded by the encircling rims are network-like structures. A plurality of grooves are provided on the opposite side of the main flat body, and on the other hand, the ramified bodies are provided with notches. The ramified bodies can be connected with the main body by straddling on both sides of the main body, and subsequently slipping the notches into the grooves, forming a structure comprising the main body and the ramified bodies. After the 3-dimensional structure is formed, bulbs and flexible light tubes are arranged on the encircling rims, wherein the bulbs are connected by electric wires, creating a Christmas decoration with the decorating effects of sparkling lights.

### FIELD OF THE INVENTION

The present invention generally relates to a structure of Christmas decoration, and more specifically to a decoration comprising a plurality of separable ramified bodies, such as animals, plants, or other inanimate 3-dimensional objects, which are provided with bulbs or flexible light tubes on their edge contours, to obtain a Christmas decoration with a special visual effect, and when not in use, the main body and its ramified bodies can be disassembled so as to reduce its volume and facilitate its storage.

### BACKGROUND OF THE INVENTION

Christmas is the most cherished festival for the Christian countries in Europe and America. On the eve of the date, every household spares no effort in preparing for the coming of the day, anticipating family reunion and beseeching happiness and well being for the coming year.

The Christmas lights, which provide special visual effects, are the indispensable decorations for the families preparing Christmas in the Christian countries of Europe and America. In general, families would hang long strings of Christmas lights on houses, trees, or other various kinds of objects for decoration. Among them, the decorated objects for hanging Christmas lights traditionally can be made from any practicable materials, but in generally the objects is made as a single piece which cannot be disassembled Thus, the voluminous decorations would cause troubles in storage later for taking up too much space when the festival is over. While some other prior decorations, though able to be knockdown in design, are complicated in assembling, and consequently time-consuming in disassembling, leading to inconvenience in use. Consequently, an object of the present invention to improve the drawback of the prior art of the Christmas decorations.

### SUMMARY OF THE INVENTION

The primary object of the present invention is to provide a structure of Christmas decorations which comprises a main body and a plurality of ramified bodies to form a 3-dimensional object, wherein the main body and the plurality of ramified bodies can be easily assembled and disassembled, convenient in use and also in storage.

The next object of the present invention is to provide a structure of Christmas decorations whose assembled 3-dimensional objects may carry strings of bulbs and light tubes, rendering the decorations with sparkling visual effects.

The following object of the present invention is to provide a structure of Christmas decorations whose assembled configuration is in the from of a reindeer, corresponding to the legend of “Santa Claus riding a reindeer-drawn sled”

Consequently, the structure provided by the present invention includes a flat main body and a plurality of ramified bodies, whose edge contours are provided with encircling rims thereof, and the areas surrounded by the encircling rims are network like structures. A plurality of grooves are provided on opposite sides of the main flat body, and on the other hand, the ramified bodies are provided with notches. The ramified bodies can be connected with the main body by straddling on both sides of the main body, and subsequently engaging the notches into the grooves, forming a structure comprising the main body and the ramified bodies. After the 3-dimensional structure is formed, bulbs and flexible light tubes are arranged on the encircling rims, wherein the bulbs are connected by electric wires, creating a Christmas decoration with the decorating effects of sparkling lights.

The other purposes and functions of the present invention can be better understood when further description is made with reference to the following figures.

### BRIEF DESCRIPTION OF THE DRAWINGS

FIG. 1 is an exploded perspective view of the present innovation illustrating the assembling relationship between the main components;

FIG.2 is a perspective view of the structure with the components, shown in FIG. 1 assembled and bulbs connected

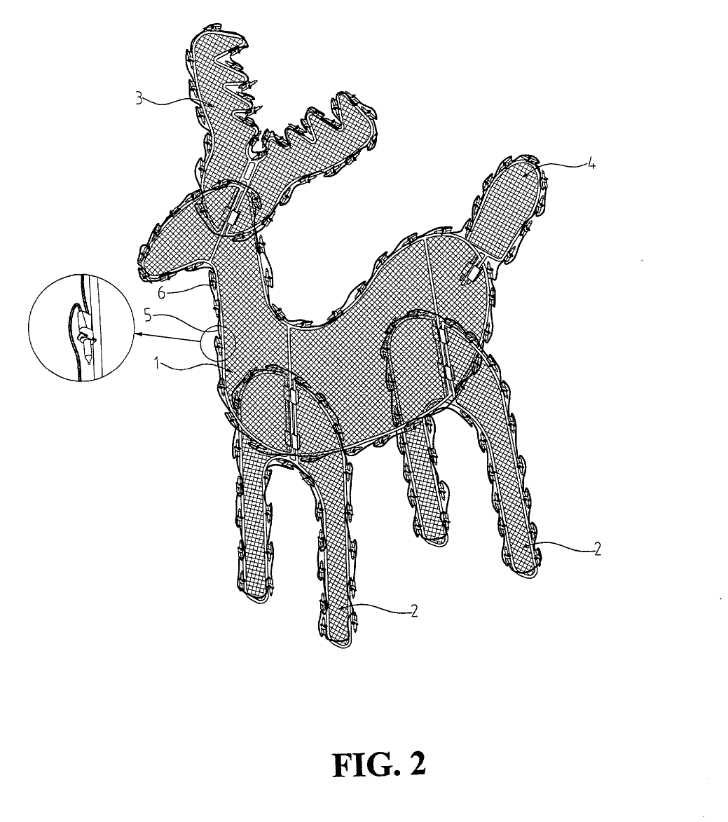

FIG. 3 is a perspective view of the structure with the components, shown in FIG. 1, assembled and flexible light tubes connected.

### DETAILED DESCRIPTION OF THE INVENTION

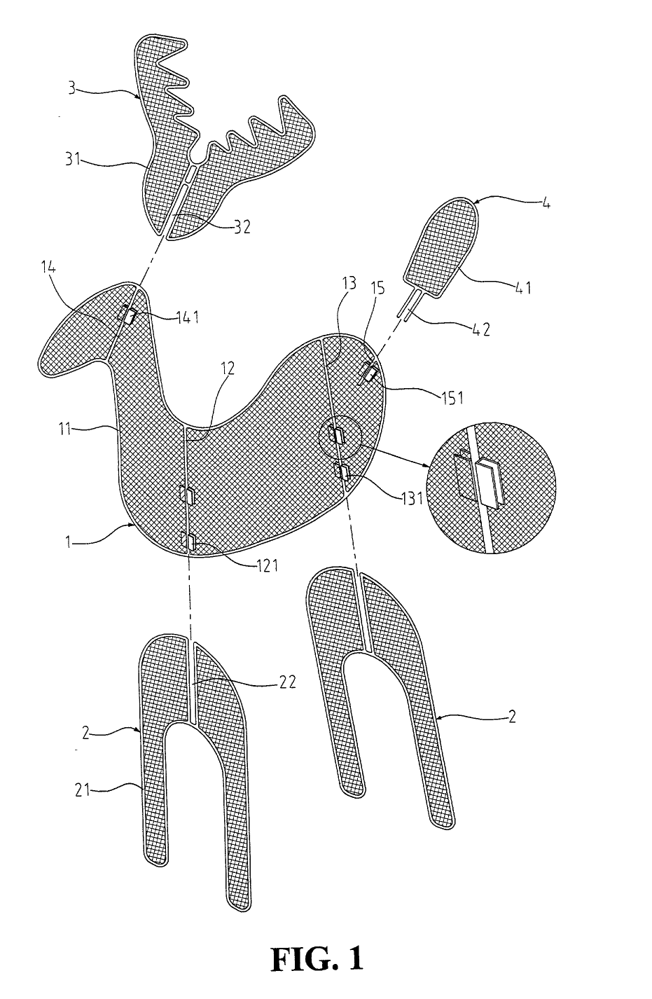

Referring to FIG. 1; one of the embodiments of the structures of Christmas decorations provided by the present invention includes one main body 1, two first ramified bodies 2, one second ramified body 3, and one third ramified body 4, wherein the main body 1, and the first, second, and third ramified bodies 2, 3, 4 are all flat objects, and the first, second, and third ramified bodies 2, 3, 4 can be assembled into a 3-dimensional structure of a “reindeer.”

The main body 1 of the present invention is designed as a flat object with a body; a neck, and a head of a reindeer, wherein the edge contour of the main body 1 is provided with wide encircling rim 11, and the area surrounded by the encircling rim 11 is a network-like structure. The area surrounded by the encircling rim 11 is provided with the reinforced ribs 12 on the front body of the reindeer, the reinforced ribs 13 on the rear body of the reindeer the reinforced ribs 14 on the head of the reindeer, and the reinforced ribs 15 on the hip of the reindeer. Also, on the both sides of areas corresponding to the reinforced ribs 12, 13, 14, and 15 are provided with grooves 121, 131, 141; and 151 for fixing. The preferred embodiment of the grooves 121, 131, 141 and 151 are a reverse shape of the letter U and the openings of the reverse U-shape grooves pointing away from to the main body 1, with the reverse U-shape grooves situated fixedly behind the reinforced ribs.

The described first ramified body 2 having front legs and rear legs of the reindeer is provided with wide encircling rim on its edge contour, wherein the area surrounded by the encircling rim 21 is a network like structure. Above the place between the two legs is arranged a notch 22 for each first ramified body 2, by which the described first ramified body 2 can be attached to the front and the rear edge contours of the main body 1, respectively, so as to slip the two inner sides of the notches 22 into the guiding grooves 122 and 131, respectively. The first ramified body 2 is then fixed on the front and rear sides of the main body 1 by the friction force between the inner walls of the guiding grooves 124 and 131, and the two sides of each notch 22, forming the front and the rear legs of the reindeer.

The described second ramified body 3 is to form the antler of the reindeer, which is a flat object. On the edge contour of the second ramified body 3 is provided with a wide encircling rim 31, wherein the area surrounded by the encircling rim 31 is a network like structure. On the edge of the second ramified body 3 is arranged a notch 31, by which the described second ramified body 3 can be attached to the edge contour of the top of the head of the main body 1 so as to slip the two inner sides of the notch 32 into the guiding groove 141. The second ramified body 3 is then fixed on the main body 1 by the friction force between the inner walls of the guiding groove 141 and the two sides of the notch 32.

The described third ramified body 4 is to form the tail of the reindeer, which is a flat object. On the edge contour of the third ramified body 4 is provided with a wide encircling rim 41, wherein the area surrounded by the encircling rim 44 is a network-like structure. On the edge of the second ramified body 4 is arranged a notch 42, by which the described third ramified body 4 can be attached to the rear edge contour of the main body 1 so as to slip the two inner sides of the notch 42 into the guiding groove 151. The second ramified body 4 is then fixed on the main body 1 by the friction force between the inner walls of the guiding groove 151 and the two sides of the notch 42, forming:the:tail of the reindeer.

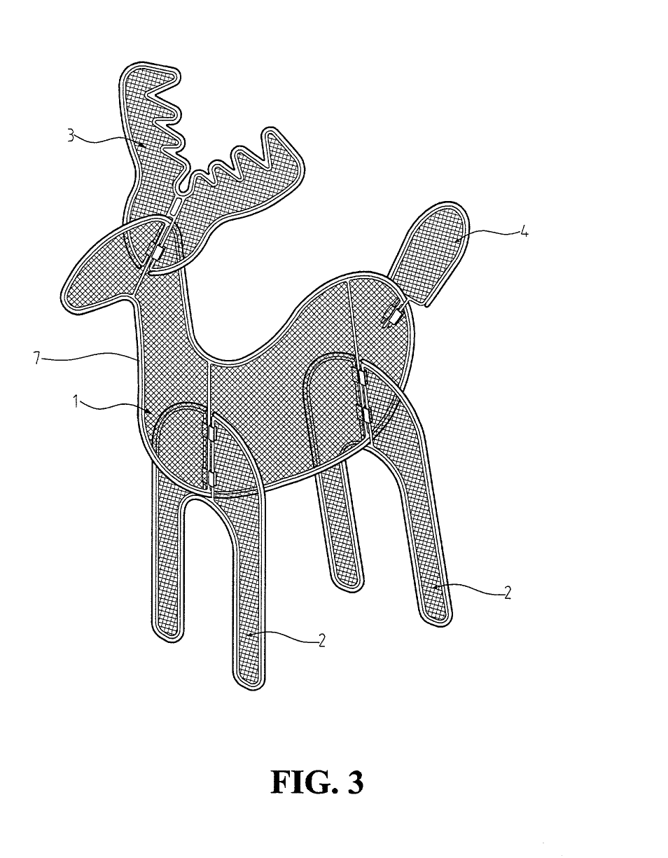

The assembly of the described main body 1, the first ramified body 2,the second ramified body 3, and the third ramified body 4 is shown as the 3dimensional structure in FIG. 1. Moreover, on the edge contours of the 3dimensional structure are provided with bulbs 6, which are connected with an electric wire 5. When the electricity provided by the wire 5 flows through the bulbs 6, the 3-dimensional structure of the reindeer can form a sparkling visual effect, enriching the Christmas bliss. Other than the bulbs 6, in the present invention, flexible light tubes 7 can be installed on the edge contours of the 3-dimensional structure instead, as shown in FIG. 3. The flexible light tubes 7 are tubes made of transparent plastics, wherein electric wires and small bulbs are provided inside the tubes. The transparent plastic tubes are flexible so that they can be arbitrarily turned and inserted at any form of objects. Because the flexible tube is a prior invention and not the emphasis of the present invention, it will not be elaborated any further.

It should be understood that the above only describes an example of one embodiment of the present invention, and that various alternations or modifications may be made thereto without departing the spirit of this invention. Therefore, the protection scope of the present invention should be based on the claims described later. What is claimed is:

1.A structure of a Christmas decoration, comprising:
a main body, which a flat object provided with a plurality of grooves on the opposite side of said main flat body;
a plurality of ramified bodies provided with notches, wherein said notches can straddle on edge contour of said main body and then the inner sides of said notches can slip into said grooves on opposite side of said main body;
a plurality of bulbs provided along the rim of said main body and said ramified bodies and connected with electric wires.

2. The structure of a Christmas decoration as claimed in claim 1, wherein said edge contour of said main body provided with encircling rim.

3. The structure of a Christmas decoration as claimed in claim 1, wherein said edge contour of said ramified bodies provided with encircling rims.

4. The structure of a Christmas decoration as claimed in claim 1, wherein said grooves are components of a reverse shape of the letter U and said reverse U-shape groove situated fixedly on said main body with the openings of said reverse U-shape grooves pointing away from said main body.

5. The structure of a Christmas decoration as claimed in claim 2, wherein the area of said main body surrounded by said encircling rim is a network like structure.

6. The structure of a Christmas decoration as claimed in claim 3, wherein the area of said ramified body surrounded by said encircling rims is a network like structure.

7. The structure of a Christmas decoration as claimed in claims 5, wherein said area surrounded by said encircling rim is provided with reinforced ribs with said grooves situated fixedly on said reinforced ribs.

8. The structure of a Christmas decoration as claimed in claim 1, wherein said main body and said plurality of ramified bodies can be assembled into a structure of a reindeer.

9. The structure of a Christmas decoration as claimed in claim 8, wherein said main body comprising flat bodies of a head, a neck, and a body of a reindeer structure, and said ramified bodies comprising the first ramified body of reindeer legs, the second ramified body of reindeer antlers, and the third ramified body of a reindeer tail.

10. The structure of a Christmas decoration as claimed in claim 1, wherein said edge contours of said main body and said ramified body may be provided with flexible light tubes.
